(19) United States
(12) Patent Application Publication
(10) Pub. No.: US 2023/0251646 A1
(43) Pub. Date: Aug. 10, 2023

(54) ANOMALY DETECTION OF COMPLEX INDUSTRIAL SYSTEMS AND PROCESSES

(71) Applicant: INTERNATIONAL BUSINESS MACHINES CORPORATION, Armonk, NY (US)

(72) Inventors: Amadou BA, Navan (IE); Fearghal O'DONNCHA, Aran Islands (IE)

(73) Assignee: INTERNATIONAL BUSINESS MACHINES CORPORATION, Armonk, NY (US)

(21) Appl. No.: 17/650,648

(22) Filed: Feb. 10, 2022

(51) Int. Cl. G05B 23/02; G05B 19/418

(52) U.S. Cl. CPC G05B 23/0275; G05B 19/4183; G05B 19/41865; G05B 19/41885

(57) ABSTRACT

Embodiments are provided for providing increased efficiency of various industrial systems and processes in a computing system by a processor. One or more anomalies may be monitored and detected for a plurality of processes of an industrial system using a machine learning operation, wherein the one or more anomalies are localized. A diagnosis is generated to address the one or more anomalies.

### BACKGROUND

The present invention relates in general to computing systems, and more particularly, to various embodiments for anomaly detection of various industrial systems and processes by a processor.

### SUMMARY

According to an embodiment of the present invention, a method for providing increased efficiency of various industrial systems and processes in a computing system in a computing environment, by one or more processors, is depicted. One or more anomalies may be monitored and detected for a plurality of processes of an industrial system using a machine learning operation, wherein the one or more anomalies are localized. A diagnosis is generated to address the one or more anomalies.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

Thus, in addition to the foregoing exemplary method embodiments, other exemplary system and computer product embodiments are provided.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is a diagram depicting an exemplary functional relationship between various aspects of the present invention.

FIG. 5A in an additional block diagram for operations for anomaly detection of various industrial systems and processes in a computing system in a computing environment according to an embodiment of the present invention.

FIG. 5B in an additional block diagram for operations for anomaly detection and explanation of various industrial systems and processes in a computing system in a computing environment according to an embodiment of the present invention.

FIG. 6 in an additional block diagram of an exemplary use case of anomaly detection and explanation of various industrial systems and processes in a computing system in a computing environment according to an embodiment of the present invention.

FIG. 7 is a flowchart diagram depicting an additional exemplary method for anomaly detection and explanation of various industrial systems and processes in a computing system in a computing environment according to an embodiment of the present invention.

FIG. 8 is a flowchart diagram depicting an additional exemplary method for monitoring various industrial systems and processes in a computing system in a computing environment according to an embodiment of the present invention.

FIG. 9 is a flowchart diagram depicting an additional exemplary method for anomaly detection and explanation of various industrial systems and processes in a computing system in a computing environment according to an embodiment of the present invention.

FIG. 10 is a flowchart diagram depicting an additional exemplary method for anomaly detection and explanation of various industrial systems and processes in a computing system in a computing environment according to an embodiment of the present invention.

### DETAILED DESCRIPTION OF THE DRAWINGS

The present invention relates generally to the field of artificial intelligence (“AI”) such as, for example, machine learning and/or deep learning. Machine learning allows for an automated processing system (a “machine”), such as a computer system or specialized processing circuit, to develop generalizations about particular data sets and use the generalizations to solve associated problems by, for example, classifying new data. Once a machine learns generalizations from (or is trained using) known properties from the input or training data, it can apply the generalizations to future data to predict unknown properties.

In machine learning and cognitive science, neural networks are a family of statistical learning models inspired by the biological neural networks of animals, and in particular the brain. Neural networks can be used to estimate or approximate systems and functions that depend on a large number of inputs and are generally unknown. Neural networks use a class of algorithms based on a concept of inter-connected “neurons.” In a typical neural network, neurons have a given activation function that operates on the inputs. By determining proper connection weights (a process also referred to as “training”), a neural network achieves efficient recognition of desired patterns, such as images and characters. Oftentimes, these neurons are grouped into “layers” in order to make connections between groups more obvious and to each computation of values. Training the neural network is a computationally intense process. For example, designing machine learning (ML) models, particularly neural networks for deep learning, is a trial-and-error process, and typically the machine learning model is a black box.

However, large scale and interconnected systems/processes are complex and difficult to monitor and difficult to gain access to a specific part of the system/process. Traditional modeling approaches are limited when the structure of the systems/processes are highly interconnected and there is need to capture the information associated with the interrelation between the various entities of the systems/processes. Currently, utilization of deep learning approaches do not allow to simultaneously detect and localize anomalies in industrial system causing at least two major challenges. First, there is no efficient way of interpreting residuals, as the residuals encompass all the predictors. A residual may be the difference between an actual output recorded by a sensor and the calculated output by a model. Second, there may be inefficient use of time and resources in case of anomalies causing a need to explore the entire system/process in order to localize and isolate the anomaly. Thus, a need exists to use deep learning to diagnose anomalies in industrial systems and provide insights, explanations, and diagnosis into the anomalies.

Accordingly, in some implementations, the present invention provides a solution for providing an intelligent computing system for increased efficiency of various industrial systems and processes in a computing system in a computing environment. One or more anomalies may be monitored and detected for a plurality of processes of an industrial system using a machine learning operation, wherein the one or more anomalies are localized. A diagnosis is generated to address the one or more anomalies. Thus, the present invention provides efficient and precise detection and localization of anomalies capable of easing the implementation of corrective measures using the intelligent computing system. Using a combination of a deep learning with physical models, one or more residuals, along with the covariance matrix analysis, increases the efficiency and ease for the detection and localization of anomalies while also providing an explainable diagnosis for the anomalies. That is, the present invention provides a novel solution by using a deep learning algorithm to perform the detection and localization of anomalies in sensors data and provides insights into the sensors describing the anomaly.

In some implementations, the present disclosure provides a recording component for collecting and recording data of industrial systems (e.g., sensors among other recordings) for modeling and online learning, and detection and localization of anomalies. A communication component is provided for connecting the recording components to one or more reading/sensor devices. The recording component are enabled to read the recorded information and display measurements, predictions and monitoring results of the behavior and performance of the various industrial systems and processes. The anomaly detection, localization and insights extraction is conducted through the analysis of the estimates provided by deep learning approaches.

In other implementations, the present invention is employed in industrial systems using a model such as, for example, a robot in a manufacturing setting. A state reconstruction is performed from available measurement. A state reconstruction may be the reconstruction of the signal that governs the behavior of the process using an state estimation technique such as, for example, a Kalman Filter. Measurement estimates may be determined from a state estimation and compare the measurement estimates from the real estimate. Measurement estimate may be the computed measurement by the model, which is compared to the real measurement and gives the residual. One or more residuals may be determined between an observation and the state estimate. An observation is the measurement by the sensor. A monitoring operation of the data provided by the sensors may be performed by exploiting the residuals. An estimated covariance (e.g., the covariance associated with each estimated parameter by the model) may be exploited to automatically localize and explain the sensor responsible of the anomaly (root cause analysis).

It should be noted as described herein, the term “intelligent” (or “cognitive/cognition”) may be relating to, being, or involving conscious intellectual activity such as, for example, thinking, reasoning, or remembering, that may be performed using a machine learning. In an additional aspect, cognitive or “intelligent may be the mental process of knowing, including aspects such as awareness, perception, reasoning and judgment. A machine learning system may use artificial reasoning to interpret data from one or more data sources (e.g., sensor-based devices or other computing systems) and learn topics, concepts, and/or processes that may be determined and/or derived by machine learning.

In an additional aspect, cognitive or “intelligent” may refer to a mental action or process of acquiring knowledge and understanding through thought, experience, and one or more senses using machine learning (which may include using sensor based devices or other computing systems that include audio or video devices). Cognitive/intelligent may also refer to identifying patterns of behavior, leading to a “learning” of one or more events, operations, or processes. Thus, the intelligent model may, over time, develop semantic labels to apply to observed behavior and use a knowledge domain or ontology to store the learned observed behavior. In one embodiment, the system provides for progressive levels of complexity in what may be learned from the one or more events, operations, or processes.

In an additional aspect, the term intelligent may refer to an intelligent system. The intelligent system may be a specialized computer system, or set of computer systems, configured with hardware and/or software logic (in combination with hardware logic upon which the software executes) to emulate human cognitive functions. These intelligent systems apply human-like characteristics to convey and manipulate ideas which, when combined with the inherent strengths of digital computing, can solve problems with a high degree of accuracy (e.g., within a defined percentage range or above an accuracy threshold) and resilience on a large scale. An intelligent system may perform one or more computer-implemented intelligent operations that approximate a human thought process while enabling a user or a computing system to interact in a more natural manner. An intelligent system may use AI logic, such as NLP based logic, for example, and machine learning logic, which may be provided as specialized hardware, software executed on hardware, or any combination of specialized hardware and software executed on hardware. The logic of the intelligent system may implement the intelligent operation(s), examples of which include, but are not limited to, question answering, identification of related concepts within different portions of content in a corpus, and intelligent search algorithms, such as Internet web page searches.

In general, such intelligent systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and intelligent; 10) Identify resonating, human-like attributes and traits from natural language; 11) Deduce various language specific or agnostic attributes from natural language; 12) Memorize and recall relevant data points (images, text, voice) (e.g., a high degree of relevant recollection from data points (images, text, voice) (memorization and recall)); and/or 13) Predict and sense with situational awareness operations that mimic human intelligent based on experiences.

Other examples of various aspects of the illustrated embodiments, and corresponding benefits, will be described further herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

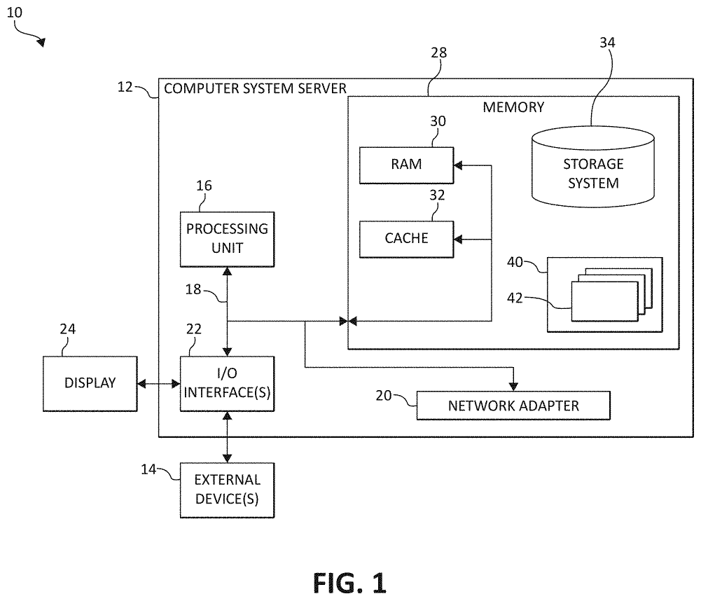

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

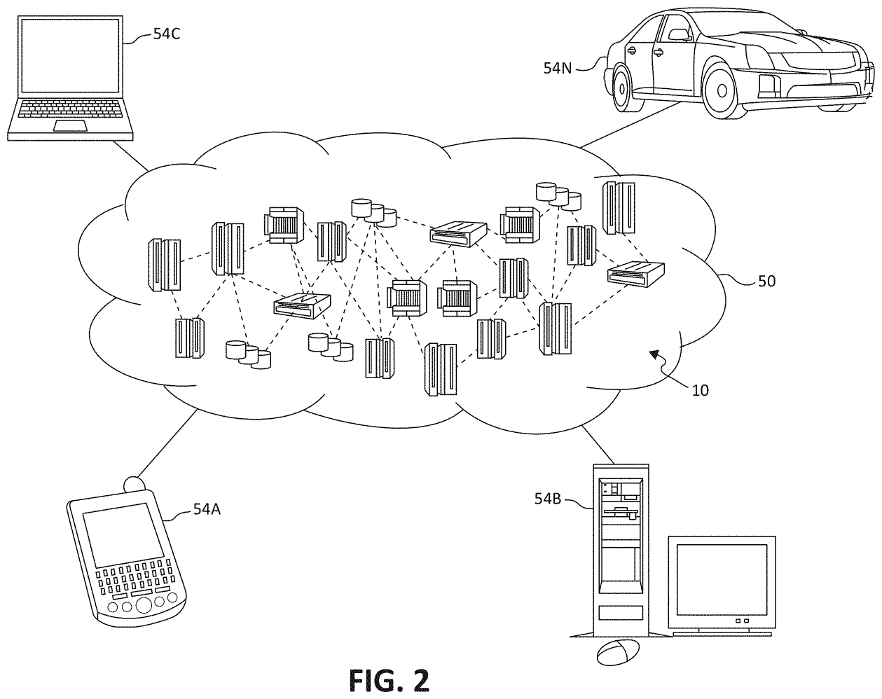

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

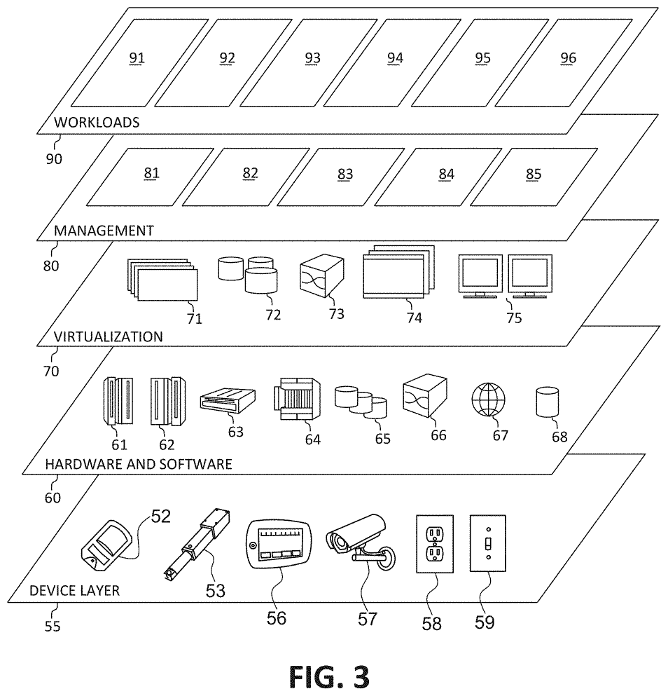

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing anomaly detection of various industrial systems and processes. In addition, workloads and functions 96 for providing anomaly detection of various industrial systems and processes may include such operations as data analytics, data analysis, and as will be further described, notification functionality. One of ordinary skill in the art will appreciate that workloads and functions 96 for providing anomaly detection of various industrial systems and processes may also work in conjunction with other portions of the various abstraction layers, such as those in hardware and software 60, virtualization 70, management 80, and other workloads 90 (such as data analytics processing 94, for example) to accomplish the various purposes of the illustrated embodiments of the present invention.

Thus, as described herein, in various implementation, the present disclosure provides for providing anomaly detection of various industrial systems and processes in a computing environment. One or more anomalies may be monitored and detected for a plurality of processes of an industrial system using a machine learning operation, wherein the one or more anomalies are localized. A diagnosis is generated to address the one or more anomalies.

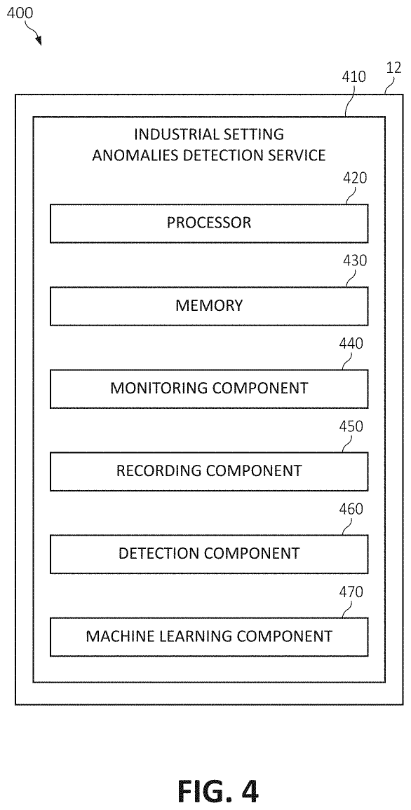

Turning now to FIG. 4, a block diagram depicting exemplary functional components of system 400 for providing increased performance of various industrial systems and processes in a computing environment according to various mechanisms of the illustrated embodiments is shown. In one aspect, one or more of the components, modules, services, applications, and/or functions described in FIGS. 1-3 may be used in FIG. 4. As will be seen, many of the functional blocks may also be considered “modules” or “components” of functionality, in the same descriptive sense as has been previously described in FIGS. 1-3.

In one aspect, the computer system/server 12 may provide virtualized computing services (i.e., virtualized computing, virtualized storage, virtualized networking, etc.) to the intelligent conversational agent management and interaction service 402 and the conversation agent 404. More specifically, the computer system/server 12 may provide virtualized computing, virtualized storage, virtualized networking and other virtualized services that are executing on a hardware substrate.

An industrial process anomaly detection service 410 is shown, incorporating processing unit 420 (“processor”) to perform various computational, data processing and other functionality in accordance with various aspects of the present invention. In one aspect, the processor 420 and memory 430 may be internal and/or external to the industrial process anomaly detection service 410, and internal and/or external to the computing system/server 12. The industrial process anomaly detection service 410 may be included and/or external to the computer system/server 12, as described in FIG. 1. The processing unit 420 may be in communication with the memory 430. The industrial process anomaly detection service 410 may include a monitoring component 440, a recording component 450, a detection component 460, and a machine learning component 470.

In one aspect, the system 400 may provide virtualized computing services (i.e., virtualized computing, virtualized storage, virtualized networking, etc.). More specifically, the system 400 may provide virtualized computing, virtualized storage, virtualized networking and other virtualized services that are executing on a hardware substrate.

The industrial process anomaly detection service 410, in association with the monitoring component 440, the recording component 450, the detection component 460, and the machine learning component 470 may monitor and detect one or more anomalies for a plurality of processes of an industrial system using a machine learning operation, where the one or more anomalies are localized; and may generate a diagnosis to address the one or more anomalies.

The industrial process anomaly detection service 410, in association with the monitoring component 440, the recording component 450, the detection component 460, and the machine learning component 470 may provide, in the diagnosis, one or more corrective measures to one or more of the plurality of processes to correct the one or more anomalies.

The industrial process anomaly detection service 410, in association with the monitoring component 440, the recording component 450, the detection component 460, and the machine learning component 470 may record data captured from one or more data sources associated with one or more of the plurality of processes.

The industrial process anomaly detection service 410, in association with the monitoring component 440, the recording component 450, the detection component 460, and the machine learning component 470 may perform a state reconstruction from data captured from one or more data sources.

The industrial process anomaly detection service 410, in association with the monitoring component 440, the recording component 450, the detection component 460, and the machine learning component 470 may identify the one or more anomalies based on weights associated with the data of one or more data sources and elements of a covariance matrix associate with the weights.

The industrial process anomaly detection service 410, in association with the monitoring component 440, the recording component 450, the detection component 460, and the machine learning component 470 may exploit an estimated covariance associated with one or more residuals.

The industrial process anomaly detection service 410, in association with the monitoring component 440, the recording component 450, the detection component 460, and the machine learning component 470 may automatically localize and provide a root cause analysis for each data source identified as causing one or more anomalies.

In some implementations, industrial process anomaly detection service 410, in association with the monitoring component 440, the recording component 450, the detection component 460, and the machine learning component 470 may transform long short-term memory networks (“LSTM”) to learn weights by using a system identification approach and subsequently analyze residuals and covariance matrix for anomaly detection and isolation. For example, the weights may be learned from the following LSTM equations:

iₜ=g(Wₓ_{ᵢ}Xₜ+Wₕ_{ᵢ}yₜ₋₁+bᵢ (1),

fₜ=g(Wₓ_{_{f}}Xₜ+Wₕ_{_{f}}yₜ₋₁+b_{f} (2),

oₜ=g(Wₓ_{ₒ}Xₜ+Wₕ_{ₒ}yₜ₋₁bₒ (3),

cₜ=fₜ∘cₜ₋₁+iₜ∘h(Wₓ_{_{c}}Xₜ+Wₕ_{_{c}}yₜ₋₁+b_{c} (4),

yₜ=oₜ∘h(cₜ) (5),

and the weights (w) being:

θₜ=wₕ_{ᵢ},bᵢ,wₓ_{_{f}},wₕ_{_{f}},b_{f},wₓ_{ₒ},wₕ_{ₒ},bₒ,wₓ_{_{c}},wₕ_{_{c}},b_{c} (6)

where w is a weight, i is the input gate, f is the forget gate, o is the output gate, c is the cell memory, y is the output signal, t is time, x is input signal, b is a bias, h is a hidden layer, and ∘ is a Hadamard product. Using the equations 1-6 yields a non-linear representation of the LSTM as indicate by the following equations:

cₜ=g(cₜ₋₁,xₜ,yₜ₋₁)+wₜ (7),

yₜ=h(cₜ,xₜ,yₜ₋₁)+vₜ (8),

with equations 7 and 8 yielding the following”

$$[ \begin{matrix}{c}_{t} \\ {y}_{t} \\ {θ}_{t}\end{matrix} ] = [ \begin{matrix}g ( {c}_{t - 1} , {x}_{t} , {y}_{t - 1} ) \\ h ( {c}_{t} , {x}_{t} , {y}_{t - 1} ) \\ {θ}_{t - 1}\end{matrix} ] + [ \begin{matrix}{w}_{t} \\ {v}_{t} \\ {e}_{t}\end{matrix} ] , \qquad ( 9 )$$

$${𝓏}_{t} = {φ}_{t}^{T} {y}_{t} + {e}_{t} . \qquad ( 10 )$$

where eₜ is the errors, zₜ is a measurement vector, and φₜ^{T} are parameters vector. However, since g and h cannot be applied to the covariates directly, a matrix of partial derivatives, also known as the Jacobian, may be calculated. At each time step, the Jacobian is determined with a current predicted state then it is used in the system identification equations (e.g., equations 1-10). This process linearizes the nonlinear functions around the current estimates.

In some implementations, the Jacobian of the measurement vector may be learned using equation 11 below:

$${H}_{t} = [ \frac{{\partial }_{{z}_{t}}}{{\partial }_{c}} , \frac{{\partial }_{{z}_{t}}}{{\partial }_{y}} , \frac{{\partial }_{{z}_{t}}}{{\partial }_{θ}} ] , \qquad ( 8 )$$

where the variables of equation 8 represent linearization of the measurement vector around the equilibrium point, and the transition matrix may be linearized using equation 12:

$${F}_{t} = [ \begin{matrix}\frac{\partial {h}_{( c , {x}_{t} , y )}}{{\partial }_{{c}_{t \vert t}}} & \frac{\partial {h}_{( c , {x}_{t} , y )}}{{\partial }_{{y}_{t \vert t}}} & \frac{\partial {h}_{( c , {x}_{t} , y )}}{{\partial }_{{θ}_{t \vert t}}} \\ \frac{\partial {g}_{( c , {x}_{t} , y )}}{{\partial }_{{c}_{t \vert t}}} & \frac{\partial {g}_{( c , {x}_{t} , y )}}{{\partial }_{{y}_{t \vert t}}} & \frac{\partial {g}_{( c , {x}_{t} , y )}}{{\partial }_{{θ}_{t \vert t}}} \\ 0 & 0 & 0\end{matrix} ] , \qquad ( 12 )$$

where the variables of equation 12 represent the linearization of the state vector around the equilibrium point.

In some implementations, industrial process anomaly detection service 410, in association with the monitoring component 440, the recording component 450, the detection component 460, and the machine learning component 470 may predict a state and covariance matrix using the following equations. Given that:

Xₜ=[cₜ,yₜ,θ] (12),

a Gaussian approximation is obtained using the following equations:

p(xₜ₋₁|zₜ₋₁)≈ [symbol] (xₜ₋₁;\hat{x}_{t-1|t-1},P_{t-1|t-1}),

p(xₜ|zₜ₋₁)≈ [symbol] (xₜ₋₁;\hat{x}_{t|t-1},P_{t|t-1}),

p(xₜ|zₜ)≈ [symbol] (xₜ₋₁;\hat{x}_{t|t-1},P_{t|t}), (13)

and

x_{t|t-1} (14),

where equation 14 is given by

c_{t|t-1}=g(c_{t-1|t-1},xₜ,y_{t-1|t-1}) (15),

y_{t|t-1}=h(c_{t-1|t-1},xₜ,y_{t-1|t-1} (16),

θ_{t|t-1}=θ_{t-1|t-1} (17)

thus yielding the predicted state covariance matrix of:

\hat{x}_{t-1|t-1}=Fₜ\hat{x}_{t-1|t-1},

P_{t|t-1}=FₜP_{t-1|t-1}Fₜ^{T}+Qₜ,

\hat{x}_{t|t}=\hat{x}_{t-1|t-1}+Kₜ(zₜ−φ_{t|t-t}^{T}\hat{x}_{t|t}−1) (18),

and the state and covariance updates obtained via equation 19;

P_{t|t}=P_{t-1|t-1}−KₜHₜP_{t|t-1} (19).

It should be noted also that machine learning component 470 may apply one or more heuristics and machine learning based models using a wide variety of combinations of methods, such as supervised learning, unsupervised learning, temporal difference learning, reinforcement learning and so forth. Some non-limiting examples of supervised learning which may be used with the present technology include AODE (averaged one-dependence estimators), artificial neural networks, Bayesian statistics, naive Bayes classifier, Bayesian network, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure.

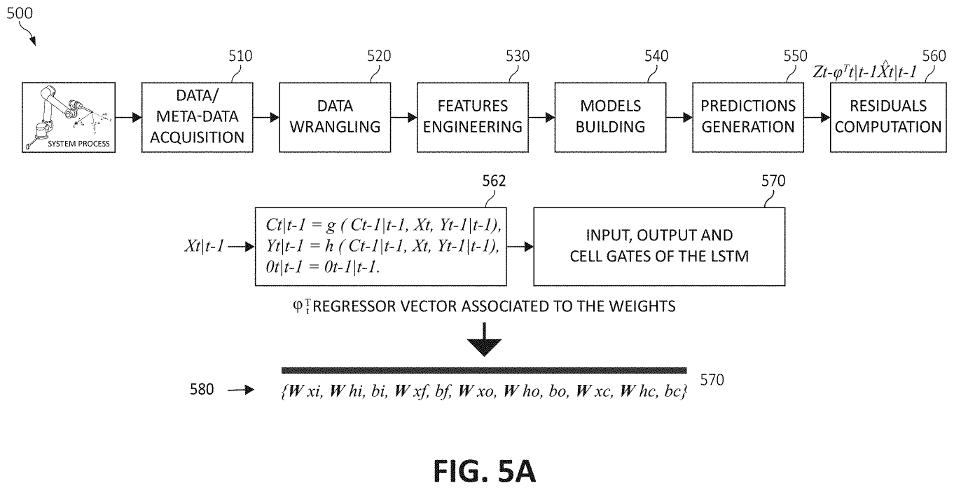

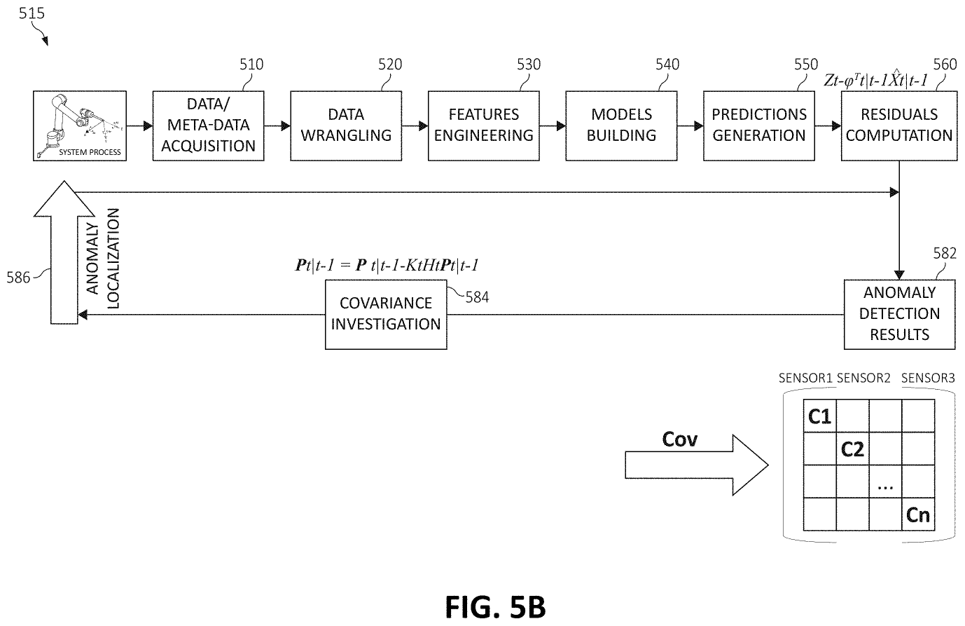

For further explanation, FIG. 5A-5B are block flow diagram depicting operations for anomaly detection of various industrial systems and processes in according to an embodiment of the present invention. In one aspect, one or more of the components, modules, services, applications, and/or functions described in FIGS. 1-4 may be used in FIGS. 5A-5B. Repetitive description of like elements employed in other embodiments described herein is omitted for sake of brevity.

Turning now to FIG. 5A, starting in block 510, data and/or metadata may be acquired from various industrial systems and processes 502. A data wrangling operation (e.g., a process of cleaning and unifying disparate data) may be performed, as in block 520. A feature engineering operation (e.g., to transform a feature to make the features provide acceptable or quality/good results to the estimation algorithms) may be performed to learn various features from the acquired data, as in block 530. A machine learning operation may be executed to build one or more models from the feature engineering, as in block 540. In block 550, the machine learning operation may generate one or more predictions (e.g., predictions generation). The predictions are a statement about the future event or data. One or more residuals may be determined/computed (e.g., using zₜ−φ_{t|t-1}_{^{\hat{x}}}_{t|t}^{T} of equation 18), as in block 560. In block 562, equations 15, 16, and 17 may be used as input to generate output and cell gates of the LSTM, as in block 570. A regressor vector may be associated to the weights 580.

Similarly, in FIG. 5B, the operations of FIG. 5A are executed (e.g., blocks 510-560) and may generate anomaly detection results, as in block 582. A covariance investigation may be executed (e.g., analyzing the covariance to identify an explanation about the prediction results), as in block 584. A diagonal matrix of a covariance (“cov”) (e.g., C1, C2, . . . , Cn) of a NLSSR-LSTM is analyzed and associated sensor (e.g., sensor 1, sensor 2, or sensor 3 of the diagonal matrix) may be isolated.

Anomaly localization may be executed by applying deep learning algorithm to perform the detection and localization of anomalies in the industrial systems and processes 502 (e.g., sensors) and provides insights into the industrial systems and processes 502 describing the anomaly, as in block 586.

Thus, using deep learning, anomaly detection and precise localization of anomalies is determined based on the analysis of residuals and covariance matrix to explain the anomaly. LSTM for explainable diagnosis of anomalies in order to allow implementation of isolated corrective measures.

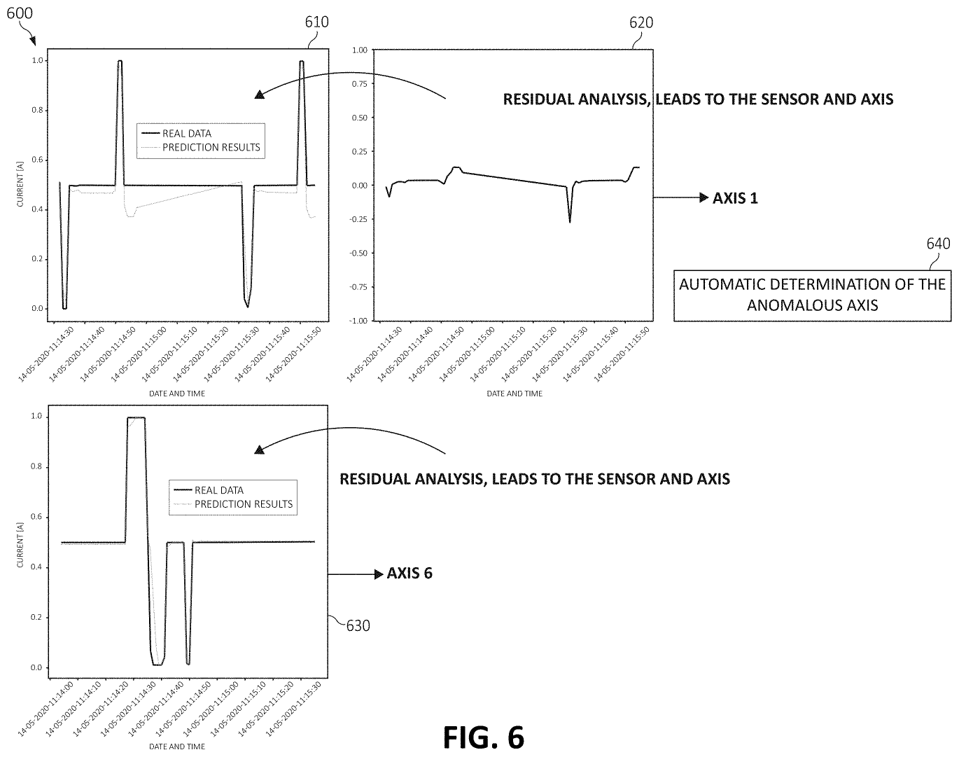

For further explanation, FIG. 6 in an additional block diagram 600 of an exemplary use case of anomaly detection and explanation of various industrial systems and processes in a computing system in a computing environment according to an embodiment of the present invention. In one aspect, one or more of the components, modules, services, applications, and/or functions described in FIGS. 1-5A-5B may be used in FIG. 6. Repetitive description of like elements employed in other embodiments described herein is omitted for sake of brevity.

As depicted, one or more continuous features were selected on the basis of various industrial process models (e.g., kinematic models) that state that a physics property (e.g., torque) is a function of speed and an angular position with a data and time on the x-axis of a graph and current (“A”) depicted on the y-axis). As the torque is not measured but is proportional to the current, the current is measured instead. Thus, graphs 610, 620, and 630 illustrates residual analysis leads to sensor and axis such as, for example, automatic determination of anomalous axis (e.g., Axis 1 or Axis 6 of rotation), as in block 640.

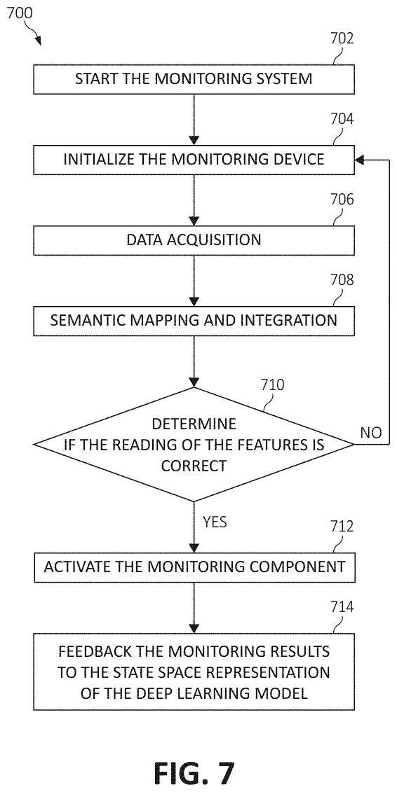

Turning now to FIG. 7, a method 700 for anomaly detection and explanation of various industrial systems and processes in a computing system by a processor is depicted, in which various aspects of the illustrated embodiments may be implemented. The functionality 700 may be implemented as a method executed as instructions on a machine, where the instructions are included on at least one computer readable medium or one non-transitory machine-readable storage medium. As one of ordinary skill in the art will appreciate, the various steps depicted in method 700 may be completed in an order or version differing from the depicted embodiment to suit a particular scenario.

The functionality 700 may start in block 702 by starting a monitoring of one or more industrial processes. A monitoring device (e.g., a recorder device) may be initialized, as in block 704. That is, one or more recorder devices of industrial systems (e.g., sensors among other recordings) may be activated for modeling and online learning, and detection and localization of anomalies. Data may be collected and acquired, as in block 706. For example, data readings from may be read (e.g., identified and analyzed from various sensors or processors associated with industrial processes or systems such as, for example, a robotic system.

A semantic mapping and integration operation may be performed, as in block 708. A determination operation may be performed to determine if the reading of the data and/or features is correct, as in block 710. If no, the method 700 may move back to block 704. If yes, the monitoring component may be activated, as in block 712. Feedback related to the monitoring (e.g., monitoring component) may be collected and may be provided to a state space representation of a deep learning model, as in block 714.

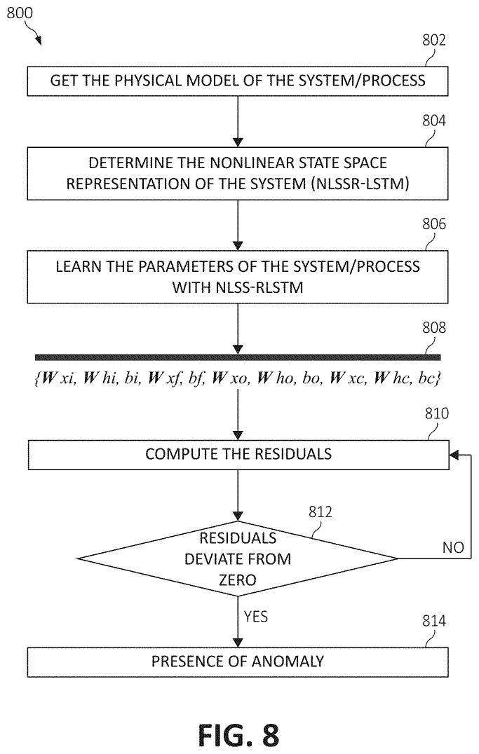

Turning now to FIG. 8, a method 800 for monitoring various industrial systems and processes by a processor is depicted, in which various aspects of the illustrated embodiments may be implemented. The functionality 800 may be implemented as a method executed as instructions on a machine, where the instructions are included on at least one computer readable medium or one non-transitory machine-readable storage medium. As one of ordinary skill in the art will appreciate, the various steps depicted in method 800 may be completed in an order or version differing from the depicted embodiment to suit a particular scenario.

The functionality 800 may start in block 802 by obtaining a physical model of one or more industrial processes and/or systems. A nonlinear state space representation (“NLSSR”) of the system (e.g., nonlinear state space representation-long short-term memory networks (“NLSSR-LSTM”) may be determined, as in block 804. One or more parameters 808 (e.g., the weights of the parameters 808 may be determined) of the one or more industrial processes and/or systems may be learned with the NLSSR-LSTM, as in block 806. One or more residuals may be determined (e.g., computed), as in block 810. A determination operation may be performed to determine if one or more of the residuals deviate from zero (e.g., deviations of a normal, anticipated, or expected operating behavior), as in block 812. If no, the method 800 returns to block 810. If yes, the method 800 moves to block 814. One or more anomalies (e.g., the presence of an anomaly) may be determined, as in block 814.

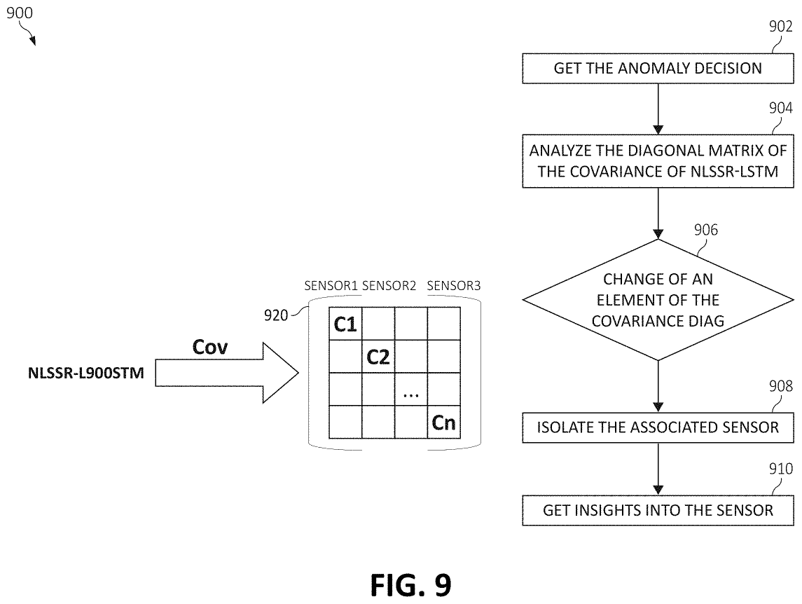

Turning now to FIG. 9, a method 900 for anomaly detection and explanation of various industrial systems and processes by a processor is depicted, in which various aspects of the illustrated embodiments may be implemented. The functionality 900 may be implemented as a method executed as instructions on a machine, where the instructions are included on at least one computer readable medium or one non-transitory machine-readable storage medium. As one of ordinary skill in the art will appreciate, the various steps depicted in method 900 may be completed in an order or version differing from the depicted embodiment to suit a particular scenario.

The functionality 900 may start in block 902 by obtaining an anomaly decision. A diagonal matrix 920 of a covariance (“cov”) (e.g., C1, C2, . . . , Cn) of a NLSSR-LSTM may be analyzed, as in block 904. A determination operation may be performed to determine if an element of the covariance of the diagonal matrix 920 needs to be changed, as in block 906. If no, the method 900 returns to block 904. If yes, the method 900 moves to block 908. An associated sensor (e.g., sensor 1, sensor 2, or sensor 3 of the diagonal matrix 920) may be isolated, as in block 908. Insights and data relating to the associated sensor may be obtained and acquired, as in block 910.

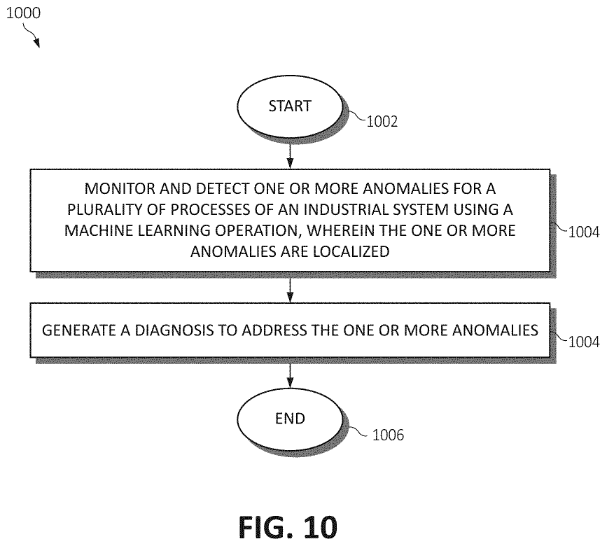

Turning now to FIG. 10, a method 1000 for anomaly detection and explanation of various industrial systems and processes by a processor is depicted, in which various aspects of the illustrated embodiments may be implemented. The functionality 1000 may be implemented as a method executed as instructions on a machine, where the instructions are included on at least one computer readable medium or one non-transitory machine-readable storage medium. As one of ordinary skill in the art will appreciate, the various steps depicted in method 1000 may be completed in an order or version differing from the depicted embodiment to suit a particular scenario.

The functionality 1000 may start in block 1002 and may monitor and detect one or more anomalies for a plurality of processes of an industrial system using a machine learning operation, wherein the one or more anomalies are localized, as in block 1004. A diagnosis (e.g., insights) to address (or explain) the one or more anomalies may be generated, as in block 1006. The method 1000 may end, as in block 1008.

In one aspect, in conjunction with and/or as part of at least one block of FIG. 10, the operations of method 1000 may include each of the following. The operations of method 1000 may include providing, in the diagnosis, one or more corrective measures to one or more of the plurality of processes to correct the one or more anomalies. The operations of method 1000 may include recording data captured from one or more data sources associated with one or more of the plurality of processes.

The operations of method 1000 may include performing a state reconstruction from data captured from one or more data sources. The operations of method 1000 may include identifying the one or more anomalies based on weights associated with the data of one or more data sources and elements of a covariance matrix associate with the weights. The operations of method 1000 may include exploiting an estimated covariance associated with one or more residuals. The operations of method 1000 may include automatically localizing and providing a root cause analysis for each data source identified as causing one or more anomalies.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for providing increased efficiency of various industrial systems and processes in a computing system in a computing environment by a processor, comprising:
monitoring and detecting one or more anomalies for a plurality of processes of an industrial system using a machine learning operation, wherein the one or more anomalies are localized; and
generating a diagnosis to address the one or more anomalies.

2. The method of claim 1, further including providing, in the diagnosis, one or more corrective measures to one or more of the plurality of processes to correct the one or more anomalies.

3. The method of claim 1, further including recording data captured from one or more data sources associated with one or more of the plurality of processes.

4. The method of claim 1, further including performing a state reconstruction from data captured from one or more data sources.

5. The method of claim 1, further including identifying the one or more anomalies based on weights associated with the data of one or more data sources and elements of a covariance matrix associate with the weights.

6. The method of claim 1, further including exploiting an estimated covariance associated with one or more residuals.

7. The method of claim 1, further including automatically localizing and providing a root cause analysis for each data source identified as causing one or more anomalies.

8. A system for providing increased efficiency of various industrial systems and processes in a computing system in a computing environment, comprising:
one or more computers with executable instructions that when executed cause the system to:
monitor and detect one or more anomalies for a plurality of processes of an industrial system using a machine learning operation, wherein the one or more anomalies are localized; and
generate a diagnosis to address the one or more anomalies.

9. The system of claim 8, wherein the executable instructions when executed cause the system to provide, in the diagnosis, one or more corrective measures to one or more of the plurality of processes to correct the one or more anomalies.

10. The system of claim 8, wherein the executable instructions when executed cause the system to record data captured from one or more data sources associated with one or more of the plurality of processes.

11. The system of claim 8, wherein the executable instructions when executed cause the system to perform a state reconstruction from data captured from one or more data sources.

12. The system of claim 8, wherein the executable instructions when executed cause the system to identify the one or more anomalies based on weights associated with the data of one or more data sources and elements of a covariance matrix associate with the weights.

13. The system of claim 8, wherein the executable instructions when executed cause the system to exploit an estimated covariance associated with one or more residuals.

14. The system of claim 8, wherein the executable instructions when executed cause the system to automatically localize and provide a root cause analysis for each data source identified as causing one or more anomalies.

15. A computer program product for providing increased efficiency of various industrial systems and processes in a computing system in a computing environment, the computer program product comprising:
one or more computer readable storage media, and program instructions collectively stored on the one or more computer readable storage media, the program instruction comprising:
program instructions to monitor and detect one or more anomalies for a plurality of processes of an industrial system using a machine learning operation, wherein the one or more anomalies are localized; and
program instructions to generate a diagnosis to address the one or more anomalies.

16. The computer program product of claim 15, further including program instructions to provide, in the diagnosis, one or more corrective measures to one or more of the plurality of processes to correct the one or more anomalies.

17. The computer program product of claim 15, further including program instructions to:
record data captured from one or more data sources associated with one or more of the plurality of processes; and
perform a state reconstruction from data captured from the one or more data sources.

18. The computer program product of claim 15, further including program instructions to identify the one or more anomalies based on weights associated with the data of one or more data sources and elements of a covariance matrix associate with the weights.

19. The computer program product of claim 15, further including program instructions to exploit an estimated covariance associated with one or more residuals.

20. The computer program product of claim 15, further including program instructions to automatically localize and provide a root cause analysis for each data source identified as causing one or more anomalies.
